(19) United States
(12) Patent Application Publication
(10) Pub. No.: US 2007/0185756 A1
(43) Pub. Date: Aug. 9, 2007

(54) Shopping pattern analysis system and method based on rfid

(75) Inventor: Jae Myung Ahn, Seoul (KR)

Correspondence Address: PARK LAW FIRM, 3255 WILSHIRE BLVD, SUITE 1110, LOS ANGELES, CA, 90010, US

(73) Assignees: Jae Myung Ahn, Seoul (KR); RETAIL TECH CO., LTD, Seoul (KR)

(21) Appl. No.: 10/593,142

(22) PCT Filed: Aug. 22, 2005
(86) PCT No.: PCT/KR05/02766

§ 371 Date: Sep. 18, 2006

(30) Foreign Application Priority Data
Aug. 23, 2004 (KR) 10-2004-0066500
Aug. 22, 2005 (KR) 10-2005-0076798

(51) Int. Cl. G07G 1/00; G06F 7/00; G08B 13/14

(52) U.S. Cl. 705/10; 340/572.1; 235/376

(57) ABSTRACT

Disclosed is a system and method for detecting a location of a consumer in a store using a RFID, analyzing a shopping traffic line of the consumer by checking shopping time of the consumer in a zone in the store and tracing the location of the consumer, and analyzing a shopping pattern of the consumer using a result of the analysis of the shopping traffic line. The system includes a tag attached to a shopping cart and having mobility corresponding to a shopping consumer; a plurality of readers for reading information of the tag through local area radio communication and transmining the read information through a network; an analysis module for analyzing a shopping pattern of the consumer from the information of the tag read by the readers; a database in which the information of the tag and analysis data of the analysis module are stored; a system server for managing the analysis data of the analysis module by performing communication with the readers, and controlling the analysis module and the database; and a monitoring terminal for receiving a result of the analysis for the shopping pattern from the system server and displaying the received' result of the analysis.

### TECHNICAL FIELD

The present invention relates to a shopping pattern analysis system, and more particularly to a system and method for detecting a location of a consumer in a store using a RFID, analyzing a shopping traffic line of the consumer by checking shopping time of the consumer in a zone in the store and tracing the location of the consumer, and analyzing a shopping pattern of the consumer using a result of the analysis for the shopping traffic line.

### Background Art

In recent years, studies of ubiquitous networking and ubiquitous computing have been actively made, and technologies for automatically recognizing locations of objects in a wireless way and detecting moving paths of the objects and systems employing such technologies have been issued.

A ubiquitous environment is an environment in which a user can receive computing services desired by him at any time and at any place. There is a need of a link technique for connecting a virtual world to a real world in order to implement such a ubiquitous environment.

An automatic recognition technique is utilized to link the virtual world to the real world. The automatic recognition technique may include a bar code system, an optical character recognition system, a smart card system, and a RFID (Radio Frequency Identification) system.

Of these systems, the RFID system is a system having the most realistic applicability to a large-scaled store and the like.

The RFID system, which implements a radio identification technique using a radio frequency, includes a transponder, which is generally called a tag, a computer, and other equipments for processing data, as basic components.

In the RFID system, a tag attached to a movable recognition object generates unique information of the tag as a response signal to a signal received from an antenna, a reader receives the generated response signal through an antenna, and a terminal (server) connected to the reader identifies a location of the recognition object by analyzing the unique information of the tag received from the reader.

The tag may be configured in different shapes, inserted into a plastic card or a human skin tissue, and embedded in and attached to other objects in various and convenient ways.

In addition, the tag may be divided into an active tag and a passive tag. The active tag is a readable and writable tag including a power supply contained therein and a passive age is a tag using energy received from an antenna connected to a reader.

An application based on the RFID has characteristics different from those of existing general applications. While flow of program execution is decided by a system request in the existing general applications, flow of program execution may be decided by a user request in the RFID-based application. That is, in the RFID-based application, an event is generated in real time when a reader identifies a tag, and a program is executed by the generated event.

Accordingly, it is desirable to utilize a RFID technique for recognizing and tracing individual objects for the purpose of achieving a complete ubiquitous computing, and there is a keen need of development of applications, which can be applied as store management systems using the RFID technique.

Particularly, in the case of large-scale stores used by a great number of persons, there is a need of development of systems, which can manage goods, analyzes shopping patterns of consumers, goods preference of consumers, etc., and utilizes results of the analysis under the ubiquitous environment.

### SUMMARY OF THE INVENTION

It is therefore an object of the present invention to provide a system and method for analyzing a shopping pattern of a consumer in order to achieve optimal store management and efficient consumer management by detecting a current location of the consumer and shopping time at the current location in a large-scale store using a RFID and analyzing a shopping traffic line of the consumer.

To achieve the above objects, according to an aspect, the present invention provides a shopping pattern analyzing system comprising a tag attached to a shopping cart and having mobility corresponding to a shopping consumer; a plurality of readers for reading information of the tag through local area radio communication and transmitting the read information through a network; an analysis module for analyzing a shopping pattern of the consumer from the information of the tag read by the readers; a database in which the information of the tag and analysis data of the analysis module are stored; a system server for managing the analysis data of the analysis module by performing communication with the readers, and controlling the analysis module and the database; and a monitoring terminal for receiving a result of the analysis for the shopping pattern from the system server and displaying the received result of the analysis.

According to another aspect, the present invention provides a shopping pattern analyzing method comprising the steps of detecting a location of a consumer in a store corresponding to a location of a tag according to a signal from the tag sensed by a reader and storing information on the detected location of the consumer in a database; checking stay shopping time in a relevant zone in which the location of the consumer is detected and storing the checked stay shopping time in the database; tracing a shopping traffic line of the consumer in association of the consumer location information and the zone in which the stay shopping time is generated and storing the traced shopping traffic line information in the database; analyzing zone preference of the consumer from the stay shopping time information and goods information, which are stored in the database, and storing the analyzed preference in database; analyzing a shopping pattern of the consumer from the shopping traffic line information, the stay shopping time information, and the goods information, which are stored in the database, and storing a result of the analysis in the database; and generating or updating shopping profile information of the consumer and storing the generated or updated shopping profile information in the database.

According to still another aspect, the present invention provides a shopping pattern analyzing method comprising the steps of registering consumer information in a database when a consumer enters a store; detecting a location of the consumer in the store corresponding to a location of a tag according to a signal from the tag sensed by a reader and storing information on the detected location of the consumer in the database; determining whether or not stay shopping time of the consumer in a certain zone in the store exceeds preset threshold time; searching for a shopping profile of the consumer stored in the database if it is determined that the stay shopping time exceeds the preset threshold time; determining whether or not a current stay shopping zone is included in the shopping profile of the consumer; selecting a preference zone of the consumer from the shopping profile information of the consumer if it is determined that the current stay shopping zone is included in the shopping profile of the consumer; transmitting information on the preference zone and information on goods of interest of the consumer in the preference zone to a consumer terminal; and adding information on a relevant moving zone to the shopping profile of the consumer stored in the database.

### BRIEF DESCRIPTION OF THE DRAWING

FIG. 1 is a block diagram of a shopping pattern analysis system according to a preferred embodiment of the present invention.

FIG. 2 is a detailed block diagram of an analysis module according to a preferred embodiment of the present invention.

FIG. 3 is an exemplary diagram of a consumer traffic line tracing screen according to a preferred embodiment of the present invention.

FIG. 4 is an exemplary diagram of a user interface screen for shopping traffic lines of individual consumers according to a preferred embodiment of the present invention.

FIG. 5 is an exemplary diagram of a user interface screen for shopping traffic lines of all consumers for each time zone according to a preferred embodiment of the present invention.

FIG. 6 is an exemplary diagram of a user interface screen for consumer congestion of each zone in a store according to a preferred embodiment of the present invention.

FIG. 7 is an exemplary diagram of a user interface screen for statistics of calculation data and results of analysis according to a preferred embodiment of the present invention.

FIG. 8 is a flow chart illustrating a shopping pattern analysis method according to an embodiment of the present invention.

FIG. 9 is a flow chart illustrating a shopping pattern analysis method according to another embodiment of the present invention.

### BEST MODE FOR CARRYING OUT THE INVENTION

Hereinafter, a shopping pattern analysis system and method according to preferred embodiments of the present invention will be described in detail with reference to the accompanying drawings.

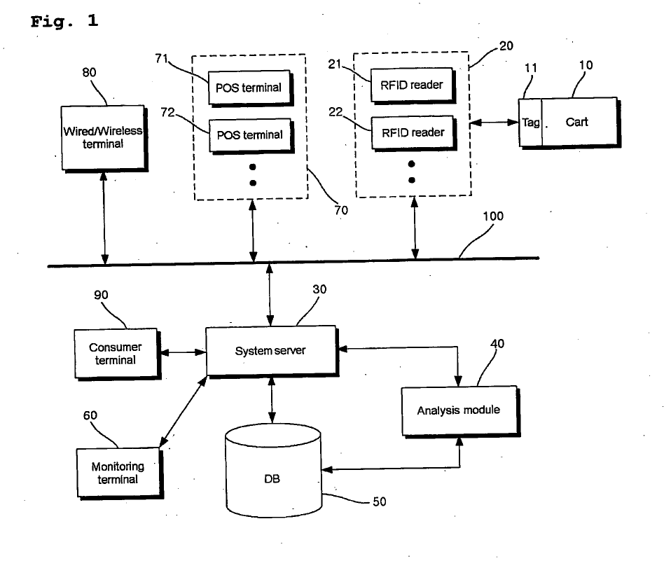

FIG. 1 is a block diagram of a shopping pattern analysis system according to a preferred embodiment of the present invention.

Referring to FIG. 1, a shopping pattern analysis system according to a preferred embodiment of the present invention includes a tag 11 attached to a shopping cart 10 or the like, a plurality of readers 21, a system server 30, an analysis module 40, a database 50, a monitoring terminal 60, a plurality of POS terminals 71, a wired/wireless terminal 80, a consumer terminal 90, and a network 100.

The tag 11 is attached at a proper position of means 10 into which goods shopped by a consumer are put (hereinafter, referred to as ‘shopping cart’), such as a shopping cart or a shopping basket provided in a store, and has a mobility corresponding to the consumer. Accordingly, a traffic line of the shopping cart 10 may be applied as a shopping traffic line of the consumer.

The plurality of readers 21, which is installed at specified positions of a goods display stand or a counter in the store, reads information of the tag 11 through local area radio communication with the tag 11, and transmits the read information to the system server 30 via the network 100. It is shown in FIG. 1 that the readers are grouped into a read unit 20.

The plurality of POS terminals 71, which is installed at the counter in the store for settling for goods shopped by the consumer, transmits information on the consumer obtained in the settlement procedure and information on the goods shopped by consumer to the system server 30 via the network 100. It is shown in FIG. 1 that the POS terminal 71 are grouped into a POS terminal unit 70.

The wired/wireless terminal 80, which is installed at an entrance and exit spot in the store, recognizes a card on which the consumer information is recorded (hereinafter, referred to as ‘consumer card’) in a contact or non-contact manner when the consumer enters the store, and transmits the consumer information recorded on the consumer card to the system server 30 via the network.

At this time, it is preferable that the readers 21 are installed at a position at which the wired/wireless terminal 80 is installed. In this case, the wired/wireless terminal 80 identifies the consumer card when the consumer enters the store, and the identified consumer information can be combined with information of the tag 11 attached to the shopping cart 10 used by the consumer.

The combined information can be used to implement a service for generating or updating shopping profile information of the consumer, analyzing and inferring information required while the consumer is shopping, and providing the inferred information to the consumer terminal 90 carried by the consumer.

If the consumer has no consumer card or the consumer information cannot be identified through the wired/wireless terminal 80 according selective intention of the consumer, the consumer information obtained by the POS terminals 71 in the settlement procedure and the tag information can be combined and managed. In this case, although the service for transmitting the information required while the consumer is shopping to the consumer terminal 90 cannot be implemented, it is possible to analyze a shopping pattern of the consumer and generate or update the shopping profile information of the consumer.

The system server 30, which is associated with the analysis module 40, the monitoring terminal 60 and the consumer terminal 80, stores various kinds of information received from the readers 21, the POS terminals 71 and the wired/wireless terminal 80 in the database 50 and controls the analysis module 40 and the database 50.

The analysis module 40 analyzes the shopping pattern of the consumer using the various kinds of information obtained from the readers 21, the POS terminals 71 and the wired/wireless terminal 80 and stores a result of the analysis in the database 50.

The database 50 stores the various kinds of information obtained from the readers 21, the POS terminals 71 and the wired/wireless terminal 80 and the analysis data of the analysis module 40.

The consumer terminal 90 receives the various kinds of information required while the consumer is shopping from the system server 30, and is preferably configured by a portable communication device such as a mobile telephone or a PDA.

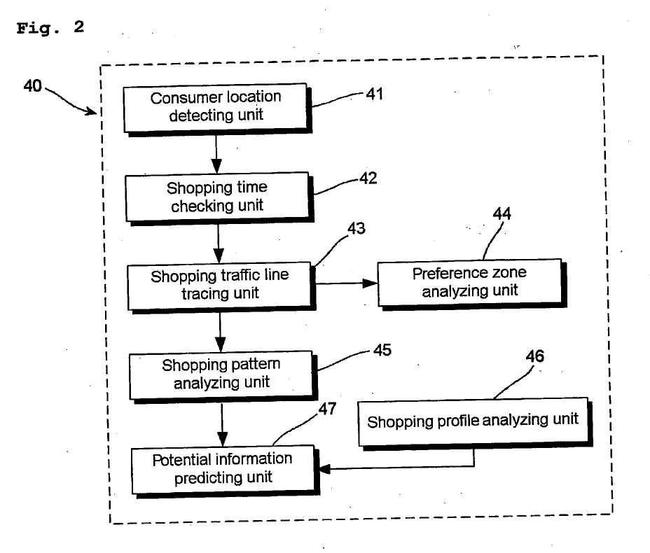

FIG. 2 is a detailed block diagram of the analysis module 40 according to a preferred embodiment of the present invention.

Referring to FIG. 2, the analysis module 40 according to the preferred embodiment of the present invention includes a consumer location detecting unit 41, a shopping time checking unit 42, a shopping traffic line tracing unit 43, a preference zone analyzing unit 44, a shopping pattern analyzing unit 45, a shopping profile analyzing unit 46, and a potential information predicting unit 47.

The consumer location detecting unit 41 detects a location of the consumer in the store, which corresponds to a location of the tag 11, based on a signal from the tag 11 sensed by the readers 21, and stores information on the detected location of the consumer in the database 50.

The shopping time checking unit 42 checks time for which the consumer stays at the detected location of the consumer in the store, determines the checked time as stay shopping time in a relevant zone if the consumer stays for more than preset threshold time, and stores a result of the determination in the database 50.

The stay shopping time in the zone is calculated using a difference between time at a current location of the consumer, which is detected by the readers 21, and time at a previous location of the consumer, according to the following Equation 1.
T_{stay, zone(x,y,z)}=|T_{in, zone(x,y,z)}−T_{out, zone(x,y,z)}|(where, T_{stay, zone(x,y,z)}≧α) [Equation 1]

T_{stay, zone(x,y,z)}: stay shopping time

T_{in, zone(x,y,z)}: time when the consumer enters a specified zone

T_{out, zone(x,y,z)}: time when the consumer departs from a specified zone

x: a horizontal axis coordinate value when the store is viewed from the top

y: a vertical axis coordinate value when the store is viewed from the top

z: the number of floors of the store

Where, the stay shopping time must be more than preset threshold time α and is determined as effective stay shopping time if the consumer stays in the relevant zone for more than the threshold time α.

The threshold time α which is allowable minimal stay time in the relevant zone, is differently defined for each goods category and is calculated according to the following Equation 2.
α=Ave[T_{stay, zone(x,y,z)}]−Ave[T_{pass, zone(x,y,z)}]

(where, Min[T_{stay}_{_{—}}_{bought, zone(x,y,z)}|≦α≦Max[T_{stay}_{_{—}}_{bought, zone(x,y,z)}]) [Equation 2]

Ave[T_{stay, zone(x,y,z)}]: average of stay shopping time for each zone

Ave[T_{pass, zone(x,y,z}]: average of moving time in a relevant zone

Max[T_{stay}_{_{—}}_{bought, zone(x,y,z)}]: maximal value of stay shopping time for each zone where the consumer actually shops

Min[T_{stay}_{_{—}}_{bought, zone(x,y,z)}]: minimal value of stay shopping time for each zone where the consumer actually shops

The threshold time α must have a value defined between the maximal value and the minimal value of the stay shopping time spent in each zone when goods in the relevant zone are actually shopped. This must be corrected.

The average moving time in the relevant zone will be differently calculated for each store depending on the length of a stand, an arrangement range of groups of goods, and the number of installed readers.

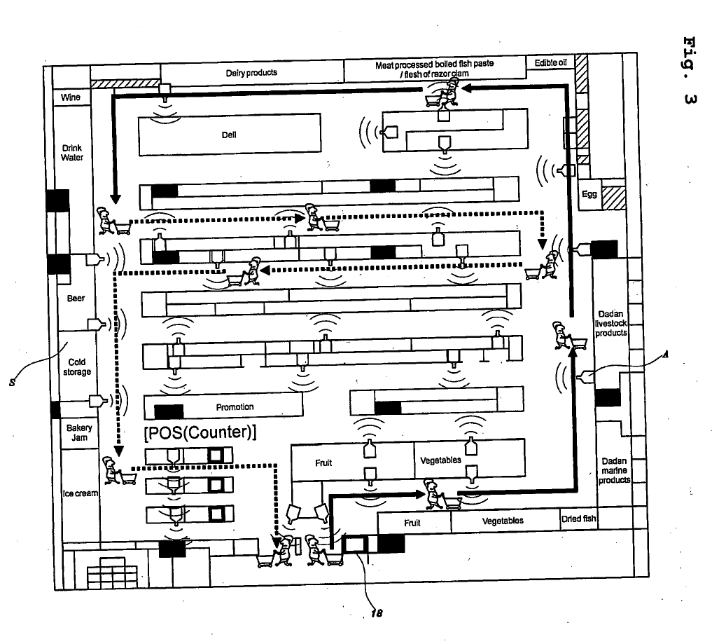

The shopping traffic line tracing unit 43 traces a shopping traffic line of the consumer in association of the location information of the consumer with a zone where the stay shopping time occurs. That is, the shopping traffic line tracing unit 43 can trace the shopping traffic line of the consumer by tracing locations of the consumer in the store and connecting the locations one another, as shown in FIG. 3.

The shopping traffic line of the consumer shown in FIG. 3 is indicated by a solid arrow, while an expected shopping traffic line drawn based on a result of inference, which will be described later, is indicated by a dotted arrow.

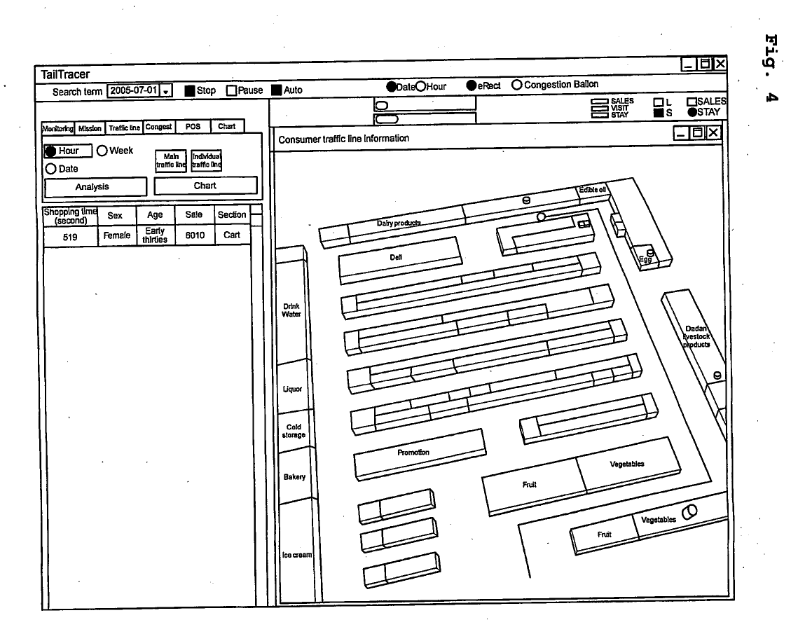

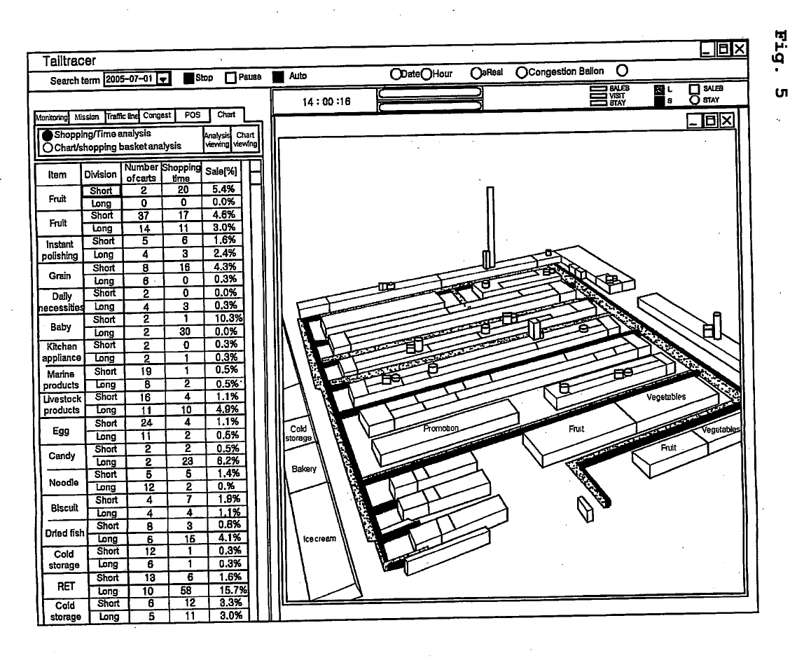

The shopping traffic line tracing unit 43 can trace and analyze shopping traffic lines of individual consumers and hourly, daily and monthly shopping traffic lines of all consumers. A result of the analysis can be displayed on a screen through the monitoring terminal 60, as shown in FIGS. 4 and 5.

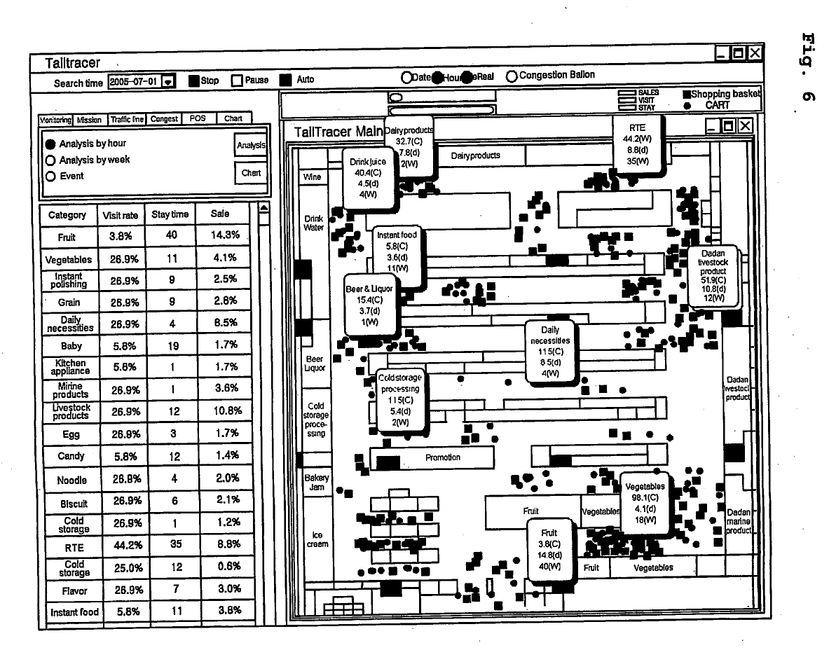

In addition, the shopping traffic line tracing unit 43 can analyze shopping congestion in each zone in the store based on information on the analyzed shopping traffic lines. The analyzed shopping congestion can be displayed on the screen through the monitoring terminal 60, as shown in FIG. 6.

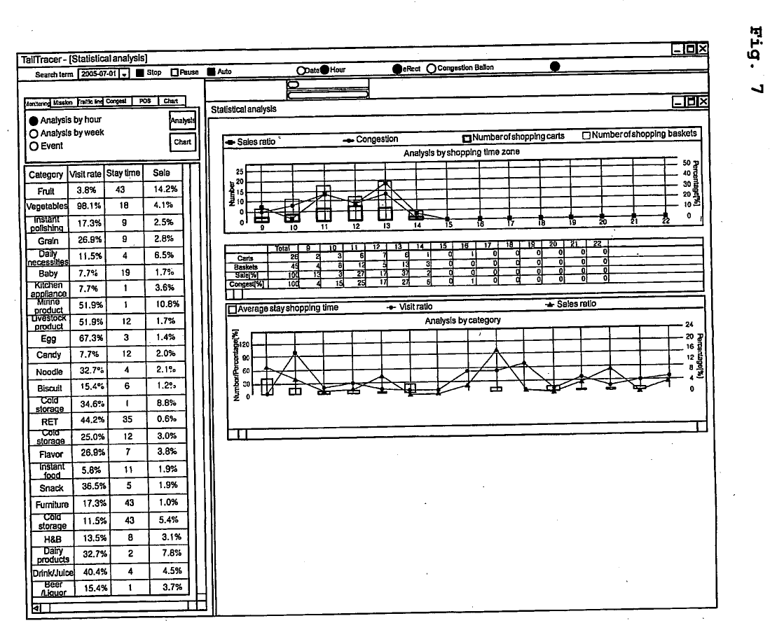

In addition, the data calculated and analyzed by the shopping traffic line tracing unit 43 can be displayed as a graph and quantitative real data values through the monitoring terminal 60, as shown in FIG. 7.

The shopping traffic line tracing unit 43 stores analyzed shopping goods information and sales information in the database 50 in association with the analyzed shopping traffic line-related information.

On the other hand, the shopping traffic line-related information stored in the database 50 may be grouped into profiles of the consumer, for example, for age, sex and the like. It is preferable that the shopping goods information and the sales information are stored in the database 50 in association with the shopping traffic line information.

As described above, the consumer location detecting unit 41, the shopping time checking unit 42 and the shopping traffic line tracing unit 43 stores the information on the location of the consumer, the stay shopping time, the shopping traffic line, respectively, in the database 50. It is preferable that the information is stored in the database 50 in association with the shopping profiles of the user.

On the other hand, various kinds of information provided by the shopping traffic line tracing unit 43 used for preference zone analysis and shopping pattern analysis, which will be described, can be provided after being registered in the database 50 or can be directly provided.

The preference zone analyzing unit 44 calculates preference of a relevant zone using the stay shopping time of the consumer for each zone and shopping information on goods in the relevant zone and stores the calculated preference in the database 50.

The zone preference, which is used to calculate a degree of consumer's interest in goods in a certain zone in the store, is calculated according to the following Equation 3.

$$\begin{matrix}{P}_{zone ( x , y , z )} = ( \frac{{\sum }_{i = 1}^{n} {C}_{bought ( i ) , zone ( x , y , z )}}{{C}_{bought , total}} \times {β}_{1} ) \times \\ ( \frac{{\sum }_{i = 1}^{n} {T}_{stay ( i ) , zone ( x , y , z )}}{{C}_{stay , total}} \times {β}_{2} )\end{matrix} \qquad [ Equation 3 ]$$

C_{bought(i), zone(x,y,z)}: the number of goods that the consumer shops in a certain zone of the store at an i^{th} shopping

C_{bought, total}: the number of goods that the consumer shops in the store

T_{stay, zone}: stay shopping time of the consumer for each zone

T_{stay, total}: the sum of stay shopping time of the consumer in the store (total shopping time)

i: the number of times of shopping

β₁: weight of shopping goods of the consumer

β₂: weight of shopping time of the consumer

As can be seen from FIG. 3, the zone preference is corrected using a shopping goods weight and a shopping time weight.

The shopping goods weight is a value used to correct the preference for goods shopped in the preference zone and reflects a degree of fidelity for relevant goods on the zone preference by calculating a shopping ratio for the relevant goods for a last shopping term. The shopping goods weight is calculated according to the following Equation 4.

$${β}_{1} = \frac{{[ {C}_{bought , area} ]}_{( {D}_{last\_shopping} - {T}_{period\_shopping} )}^{{D}_{last\_shopping}}}{{C}_{bought , total\_area}} \\ {T}_{period\_shopping} = \frac{{S}_{term\_shopping}}{{C}_{term\_shopping}} \qquad [ Equation 4 ]$$

Cₜₑᵣₘ_{_{—}}_{shoppng}: the number of times of shopping (visiting) of the consumer for a certain term

Sₜₑᵣₘ_{_{—}}_{shopping}: shopping term standard (a month, quarter of a year, a year: optional items)

T_{period}_{_{—}}_{shopping}: shopping period (store visit period)

$${[ {C}_{bought\_area \_id} ]}_{( {D}_{last\_shopping} - {T}_{period\_shopping} )}^{{D}_{last\_shopping}}$$

: the number of times of goods shopping in a relevant zone for a last shopping term

C_{bought, total}_{_{—}}ₐᵣₑₐ: the number of time of goods shopping in all zones

The shopping time weight is a value used to correct preference for a relevant zone by calculating shopping time in the relevant zone in the zone preference of the consumer and grants objectivity to shopping time in the relevant zone by correcting shopping time errors caused by event goods, seasonal goods, and shopping periods of individual consumers. The shopping time weight is calculated according to the following Equation 5.

$$\begin{matrix}{β}_{2} = \frac{{[ {T}_{shopping , area\_id} ]}_{( {D}_{last\_shopping} - {T}_{period\_shopping} )}^{{D}_{last\_shopping}}}{{[ {T}_{shopping , area\_all} ]}_{( {D}_{last\_shopping} - {T}_{period\_shopping} )}^{{D}_{last\_shopping}}} \\ {[ {T}_{shopping , area\_id} ]}_{( {D}_{last\_shopping} - {T}_{period\_shopping} )}^{{D}_{last\_shopping}}\end{matrix} \qquad [ Equation 5 ]$$

: shopping time in a relevant zone for a last shopping term

$${[ {T}_{shopping , area\_all} ]}_{( {D}_{last\_shopping} - {T}_{period\_shopping} )}^{{D}_{last\_shopping}}$$

: shopping time in all zones for a last shopping term

The shopping pattern analyzing unit 45 analyzes the consumer profile, the shopping profile, and the shopping traffic line information, which are stored in the database 50, groups the shopping pattern for each item of the consumer profile, infers shopping patterns for consumers who have similar profile information, and then stores a result of the inference in the database 50.

The shopping profile analyzing unit 46 generates or updates the shopping profiles for the consumers with reference to the consumer information and shopping history of the consumer and shopping history of a consumer group related to the consumer, which are stored in the database 50, analyzes the generated or updated shopping profiles, stores a result of the analysis in the database 50, and provides the stored result to the potential information predicting unit 47 through a separate medium or directly.

The potential information predicting unit 47 transmits goods recommendation information individualized with reference to goods shopping particulars of the consumer, the shopping traffic line information, the shopping profile and the zone preference, which are stored in the database 50, to the consumer terminal 90 carried by the consumer.

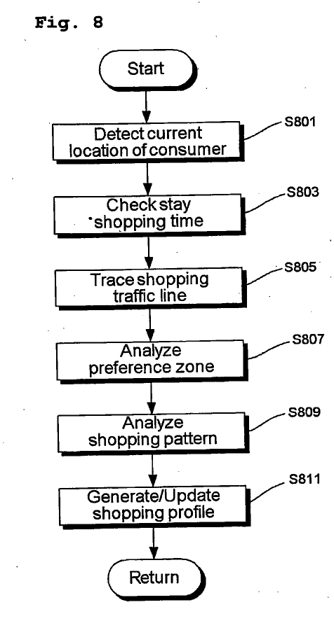

FIG. 8 is a flow chart illustrating a shopping pattern analysis method according to an embodiment of the present invention.

First, when the consumer enters the store and locates at a location within the store, the consumer location detecting unit 41 detects a current location of the consumer corresponding to the tag 11 according to a signal from the tag 11 sensed by the reader 21 (Step S801). Information on the detected location of the consumer is stored in the database 50.

When the current location of the consumer is detected, the shopping time checking unit 42 checks whether or not a term during which the consumer stays in a relevant zone is stay shopping time (Step S803).

When the term during which the consumer stays in the relevant zone exceeds a preset threshold value as minimal stay shopping time in the relevant zone, the term is determined to be the stay shopping time.

Next, the shopping traffic line tracing unit 43 traces the shopping traffic line of the consumer in association of the location information of the consumer with the relevant zone where the stay shopping time is generated, until the consumer finishes settlement for goods shopped by him and exits the store (Step S805). The information on the traced shopping traffic line is stored in the database 50.

The consumer information and the goods information obtained in the settlement procedure through the POS terminal 71 are stored in the database 50.

Next, the preference zone analyzing unit 44 analyzes a preference zone of the consumer using the stay shopping time information and the goods shopping information of the relevant zone stored in the database 50 (Step S807). The analyzed preference zone information is stored in the database 50.

Next, the shopping pattern analyzing unit 45 analyzes the shopping pattern of the consumer using the shopping traffic line information, the stay shopping time information and the goods information, which are stored in the database 50 (Step S809), and stores a result of the analysis in the database 50.

Finally, the shopping profile analyzing unit 46 generates or updates the shopping profile of the consumer (Step S811), analyzes the generated or updated shopping profile, and then stores a result of the analysis in the database 50.

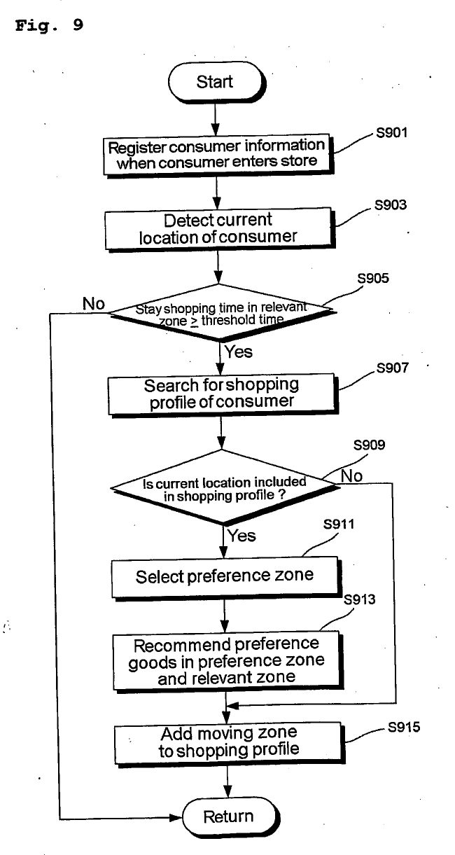

FIG. 9 is a flow chart illustrating a shopping pattern analysis method according to another embodiment of the present invention.

First, when the consumer enters the store, consumer information is registered in the database 50 (Step S901).

The registration of the consumer information is achieved by the wired/wireless terminal 80, which is installed at an entrance and exit spot of the store for identifying a card on which the consumer information is recorded in a contact or non-contact manner.

Next, the consumer location detecting unit 41 detects a current location of the consumer in the store corresponding to the tag 11 according to a signal from the tag 11 sensed by the reader 21 (Step S903). Information on the detected location of the consumer is stored in the database 50.

When the current location of the consumer is detected, the shopping time checking unit 42 checks a term during which the consumer stays in a relevant zone, and determines whether or not the term exceeds a preset threshold value (Step S905).

As a result of the determination, if the term during which the consumer stays in the relevant zone exceeds the threshold value, the potential information predicting unit 47 searches for the shopping profile information of the consumer stored in the database 50 (Step S907), and determines whether or not information on a zone in which the consumer locates currently is included in the shopping profile information of the consumer (Step 909).

If it is determined that the information on the zone is included in the shopping profile information, a preference zone having the greatest number of times of visits of the consumer in the shopping profile information is selected (Step S911). The selected preference zone is considered as a moving expectation zone of the consumer.

Finally, the potential information predicting unit 47 transmits information on the selected preference zone and information on goods of interest in the relevant zone to the consumer terminal 90 carried by the consumer (Step S913) and adds information on the relevant zone to which the consumer moves to the shopping profile information (Step S915).

### INDUSTRIAL APPLICABILITY

According to the present invention, by detecting locations of consumers in the store using RFID tags attached to shopping carts and analyzing shopping locations, shopping time and shopping traffic lines of the consumers, optimal store management and customized services for individual consumers using shopping patterns of the consumers in the store can be provided.

Particularly, the consumers can shop conveniently by providing recommendation of goods individualized according to current locations of the consumers in the store and information on locations of recommended goods.

In addition, according to the present invention, efficiency of store management can be improved by providing various kinds of information to a manager of the store so that he can analyze the present situation of the store visually or quantitatively through a monitoring terminal.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

1. A shopping pattern analyzing system comprising:
a tag attached to a shopping cart and having mobility corresponding to a shopping consumer;
a plurality of readers for reading information of the tag through local area radio communication and transmitting the read information through a network;
an analysis module for analyzing a shopping pattern of the consumer from the information of the tag read by the readers;
a database in which the information of the tag and analysis data of the analysis module are stored;
a system server for managing the analysis data of the analysis module by performing communication with the readers, and controlling the analysis module and the database; and
a monitoring terminal for receiving a result of the analysis for the shopping pattern from the system server and displaying the received result of the analysis.

2. The shopping pattern analyzing system according to claim 1, further comprising a wired/wireless terminal installed at an entrance and exit spot of a store for identifying a card on which consumer information is recorded,
wherein the shopping pattern analyzing system manages a shopping profile of the consumer using a combination of the consumer information and the tag information.

3. The shopping pattern analyzing system according to claim 2, further comprising a consumer terminal for receiving information on a shopping expectation zone of the consumer and information on goods of interest in a relevant zone, which are analyzed by the analysis module.

4. The shopping pattern analyzing system according to claim 1, further comprising a plurality of POS terminals for settling goods shopped by the consumer,
wherein the shopping pattern analyzing system manages a shopping profile of the consumer using a combination of the consumer information and the tag information, which are used for settlement.

5. The shopping pattern analyzing system according to claim 1, wherein the analysis module includes:
a consumer location detecting unit for detecting a location of the consumer in a store corresponding to a location of the tag according to a signal from the tag sensed by the readers and storing information on the detected location of the consumer in the database;
a shopping time checking unit for checking a term during which the consumer stays in the detected location in the store, determines the term as stay shopping time in a relevant zone if the consumer stays in the relevant zone for preset threshold time, and storing the stay shopping time in the database; and
a shopping traffic line tracing unit for tracing a shopping traffic line of the consumer in association of the consumer location information and the stay shopping time information in the relevant zone and storing the shopping traffic line information in the database.

6. The shopping pattern analyzing system according to claim 5, wherein the analysis module further includes:
a preference zone analyzing unit for calculating preference of the relevant zone using stay shopping time of the consumer for each zone and shopping information on goods in the relevant zone and storing the calculated preference in database; and
a shopping pattern analyzing unit for analyzing profile information of the consumer, shopping particulars of the consumer, and the shopping traffic line information, which are stored in the database, grouping the shopping pattern of the consumer for each item of the consumer profile, inferring shopping patterns for different consumers having similar profile information, and storing a result of the inference in the database.

7. The shopping pattern analyzing system according to claim 5, wherein the analysis module includes:
a shopping profile analyzing unit for generating or updating a shopping profile of the consumer with reference to the consumer information and shopping history of the consumer and shopping history of a consumer group related to the consumer, which are stored in the database, analyzing the generated or updated shopping profile, and storing a result of the analysis in the database; and
a potential information predicting unit for providing goods recommendation information individualized with reference to goods shopping particulars of the consumer, the shopping traffic line information, the shopping profile, and zone preference, which are stored in the database, to a consumer terminal carried by the consumer.

8. The shopping pattern analyzing system according to claim 5, wherein the threshold time is calculated by subtracting an average of moving time of the consumer in the relevant zone from an average of stay shopping time for each relevant zone, and is defined between maximal stay shopping time and minimal stay shopping time, which are spent in each zone when relevant zone goods are shopped actually.

9. The shopping pattern analyzing system according to claim 5, wherein the shopping traffic line information is grouped for each profile of the consumer, and the grouped shopping traffic line information is stored in the database.

10. The shopping pattern analyzing system according to claim 6, wherein the preference of the relevant zone is calculated by multiplying a ratio of the number of goods shopped in a certain zone in the store to the number of goods shopped in all zones in the store by a ratio of stay shopping time of the consumer for each zone to total shopping time of the consumer, and is corrected using a shopping goods weight and a shopping time weight.

11. The shopping pattern analyzing system according to claim 10, wherein the shopping goods weight is calculated by a radio of the quantity of goods shopping in the relevant zone during a specified term including a final point of time of shopping for goods that have ever been shopped in the store to the overall quantity of goods shopping in the relevant zone.

12. The shopping pattern analyzing system according to claim 10, wherein the shopping time weight is calculated by a radio of goods shopping time in the relevant zone during a specified term including a final point of time of shopping to overall goods shopping time in the store during the specified term including the final point of time of shopping.

13. The shopping pattern analyzing system according to claim 5,
wherein the shopping traffic line tracing unit traces and analyzes shopping traffic lines of individual consumers and hourly, daily and monthly shopping traffic lines of all consumers, and displays a result of the analysis through the monitoring terminal.

14. The shopping pattern analyzing system according to claim 5,
wherein the shopping traffic line tracing unit analyzes shopping congestion in each zone in the store and displays the analyzed shopping congestion through the monitoring terminal.

15. The shopping pattern analyzing system according to claim 5,
wherein information on the shopping traffic line and the shopping pattern of the consumer is calculated and analyzed, and a result of the analysis is displayed as a graph and quantitative real data values through the monitoring terminal.

16. A shopping pattern analyzing method comprising the steps of:
detecting a location of a consumer in a store corresponding to a location of a tag according to a signal from the tag sensed by a reader and storing information on the detected location of the consumer in a database;
checking stay shopping time in a relevant zone in which the location of the consumer is detected and storing the checked stay shopping time in the database;
tracing a shopping traffic line of the consumer in association of the consumer location information and the zone in which the stay shopping time is generated and storing the traced shopping traffic line information in the database;
analyzing zone preference of the consumer from the stay shopping time information and goods information, which are stored in the database, and storing the analyzed preference in database;
analyzing a shopping pattern of the consumer from the shopping traffic line information, the stay shopping time information, and the goods information, which are stored in the database, and storing a result of the analysis in the database; and
generating or updating shopping profile information of the consumer and storing the generated or updated shopping profile information in the database.

17. The shopping pattern analyzing method according to claim 16, wherein the stay shopping time is determined to be stay shopping time in a certain the relevant zone if it is checked whether a term during which the consumer stays in the certain zone exceeds preset threshold time.

18. The shopping pattern analyzing method according to claim 17, wherein the threshold time is calculated by subtracting an average of moving time of the consumer in the relevant zone from an average of stay shopping time for each relevant zone, and is defined between maximal stay shopping time and minimal stay shopping time, which are spent in each zone when relevant zone goods are shopped actually.

19. The shopping pattern analyzing method according to claim 16, wherein the zone preference is calculated by multiplying a ratio of the number of goods shopped in a certain zone in the store to the number of goods shopped in all zones in the store by a ratio of stay shopping time of the consumer for each zone to total shopping time of the consumer, and is corrected using a shopping goods weight and a shopping time weight.

20. The shopping pattern analyzing method according to claim 19, wherein the shopping goods weight is calculated by a radio of the quantity of goods shopping in the relevant zone during a specified term including a final point of time of shopping for goods that have ever been shopped in the store to the overall quantity of goods shopping in the relevant zone.

21. The shopping pattern analyzing method according to claim 19, wherein the shopping time weight is calculated by a radio of goods shopping time in the relevant zone during a specified term including a final point of time of shopping to overall goods shopping time in the store during the specified term including the final point of time of shopping.

22. A shopping pattern analyzing method comprising the steps of:
registering consumer information in a database when a consumer enters a store;
detecting a location of the consumer in the store corresponding to a location of a tag according to a signal from the tag sensed by a reader and storing information on the detected location of the consumer in the database;
determining whether or not stay shopping time of the consumer in a certain zone in the store exceeds preset threshold time;
searching for a shopping profile of the consumer stored in the database if it is determined that the stay shopping time exceeds the preset threshold time;
determining whether or not a current stay shopping zone is included in the shopping profile of the consumer;
selecting a preference zone of the consumer from the shopping profile information of the consumer if it is determined that the current stay shopping zone is included in the shopping profile of the consumer;
transmitting information on the preference zone and information on goods of interest of the consumer in the preference zone to a consumer terminal; and
adding information on a relevant moving zone to the shopping profile of the consumer stored in the database.

23. The shopping pattern analyzing method according to claim 22, wherein the registration of the consumer information is achieved by a wired/wireless terminal installed at an entrance and exit spot of the store for identifying a card on which the consumer information is recorded in a contact or non-contact manner.

24. The shopping pattern analyzing method according to claim 22, wherein the threshold time is calculated by subtracting an average of moving time of the consumer in the relevant zone from an average of stay shopping time for each relevant zone, and is defined between maximal stay shopping time and minimal stay shopping time, which are spent in each zone when relevant zone goods are shopped actually.
